(19) United States
(12) Patent Application Publication
(10) Pub. No.: US 2015/0344132 A1
(43) Pub. Date: Dec. 3, 2015

(54) HELICOPTER

(71) Applicants: Peter Jeney, Zug (CH); Branimir Jojic, Belgrade (RS)

(72) Inventors: Peter Jeney, Zug (CH); Branimir Jojic, Belgrade (RS)

(73) Assignee: UNMANNED SYSTEMS AG, Zug (CH)

(21) Appl. No.: 14/442,449

(22) PCT Filed: Nov. 13, 2012
(86) PCT No.: PCT/EP2012/072454

§ 371 Date: May 13, 2015

(51) Int. Cl. B64C 27/14; B64D 37/00; B64D 35/02

(52) U.S. Cl. CPC B64C 27/14; B64D 35/02; B64D 37/00

(57) ABSTRACT

Helicopter with tip-jet rotor drive comprising at least two rotor blades attached to a central shaft, where each rotor blade comprises means for guiding a fluid from a location close to said central shaft towards a tip of the rotor blade. At the area of said tip there is an outlet arranged so that by each of the rotor blades a jet stream is generated. The helicopter comprises a compressor for releasing compressed air. This compressor is co-axially arranged with respect to said central shaft above the rotor blades. The compressor is connected to the rotor blades to feed compressed air into the rotor blades. A piping system is provided for feeding fuel into the rotor blades. Each rotor blade comprises a combustion zone and means for bringing the fuel and compressed air together so that a combustion process is maintained which produces the jet streams.

### CROSS-REFERENCE TO RELATED APPLICATIONS

This application is entitled to the benefit of and incorporates by reference subject matter disclosed in International Patent Application No. PCT/EP2012/072454 filed on Nov. 13, 2012.

### FIELD OF THE INVENTION

The present invention relates to a rotor tip jet helicopter. More specifically, the present invention relates to helicopters having a rotor driven by jet streams exiting at high velocity through outlets located at the tips of the rotor blades.

### BACKGROUND FOR THE INVENTION

Rotary winged aircraft or helicopters, as they are more commonly known, comprise a fuselage and a generally vertical shaft having a lower end which is mounted within the fuselage. They also include a plurality of rotor blades which rotate about the shaft. Helicopters use the rotor blades to create a force, perpendicular to the plane created by the rotating rotor blades. This force has a component, called the lift force, which is in opposition with the gravitational force present between the earth and the helicopter. The lift force causes the helicopter to rise if it is greater than the gravitational force.

To rotate the main rotor, it is necessary to exert a force thereon. To exert this force, conventional helicopters utilize a piston engine or a turbo shaft engine having the vertical shaft mechanically linked to the rotor blades. These types of helicopters will hereinafter be referred to as mechanical helicopters. These mechanical helicopters include pieces of equipment of great complexity as a number of mechanical components, such as reduction boxes, driving shafts, gears, freewheels, etc., are required to efficiently transfer the mechanical power from a rotating shaft of the engine via the vertical shaft to the rotor blades.

In mechanical helicopters, the power is transmitted from the engine to the main rotor blades as a driving torque. This driving torque induces a fuselage torque which has the same amplitude as the driving torque, but is of opposite direction. This fuselage torque imparts a rotational motion to the fuselage in the direction opposite to the direction of rotation of the main rotor blades. In order to compensate for the induced fuselage torque, and therefore to prevent the undesired rotation of the whole fuselage, a compensation torque is applied to the fuselage of conventional mechanical helicopters. This compensation torque is created by a second rotor having a rotation axis perpendicular to the rotation axis of the main rotor. This second rotor is mounted on the tail of the helicopter. The compensation torque produced by this tail rotor is a function of the speed of rotation of the tail rotor, of its pitch and of the distance between the shafts of the main and tail rotors.

Another type of known helicopter, hereinafter referred to as tip jet driven helicopter, uses the power of gases discharged through the tip of the main rotor blades to impart rotating motion to the rotor. No torque is transferred from the fuselage to the rotor. There are a number of constructions of tip jet driven helicopters, some of which will be briefly discussed hereinafter.

Some of these tip jet driven helicopters comprise ram jets which are located at the tips of the rotors or blades. For example, the Hiller HOE-1 tip-jet helicopter, a small ram jet power helicopter, comprised two HJ-1 Hornet tip mounted ram jet power units.

However, the use for tip mounted ram jets has not proven to be very useful because the ram jets are inefficient at the very high speeds that are observed at the tips of the rotor blades. These high speeds lead to extremely large centrifugal forces acting on the tip mounted ram jets.

The respective principle presumably was developed and realized for the first time by Friedrich Baron von Doblhoff. Doblhoff's principle of a tip-jet driven rotor is based on a fuel/air mixture which is fed through hollow rotor blades using a compressor driven by an aircraft engine and that is ignited at the end of the blades. Details of one of the various Doblhoff helicopters are disclosed in U.S. Pat. No. 2,818,223, filed 1947. The Doblhoff/WNF 342 is believed to be the first helicopter to take off and land using tip jet driven rotor blades.

A similar approach was described and claimed in the patent specification GB556,866, filed on 22 Apr. 1942.

There is a two-seater tip jet driven helicopter, called SO-1221 “Djinn”, which is based on this principle, too. This helicopter is also referred to as cold-flow rotor helicopter. The SO-1221 “Djinn” has a rotor with two hollow blades. A modified turbo shaft engine with an air compressor supplies a combustion chamber of a central engine. Most of the compressed air exiting the air compressor is ducked to a hollow oscillating rotor hub, then passes through longitudinal passages of the hollow rotor blades. Finally, the compressed air is discharged by nozzles located at the tip of the blades.

The high fuel consumption was one great disadvantage of these early solutions.

The international patent application WO09625328 A1 shows an improved form of a tip jet driven helicopter 10 where compressed air from a central engine 12 is released at the tip ends 16.1, 16.2 to produce a rotating motion. A respective illustration is enclosed as FIG. 1. The helicopter 10 further includes a fuselage 14 and a generally vertical shaft 18 with a lower end mounted within the fuselage 14. The engine 12 and a tank 17 are located inside the fuselage 14.

It is one major disadvantage of tip jet driven helicopters 10 with central engine 12 that the efficiency of its drive system is low. The power transmission efficiency found in mechanical helicopters is usually much higher.

Other tip jet driven helicopters comprise a central engine, typically located inside the fuselage, which generates a gas stream which is then guided through hollow rotor blades towards the tip end. The gas stream is discharged through the tip of the main rotor blades to impart a rotating motion. One of the problems is the handling of the gas stream which is typically very hot.

There are also helicopters with liquid propellant rocket engines fitted on the rotor blade tips. One of the most recent examples is the “Intora Firebird”, a helicopter using hydrogen peroxide (H₂O₂) rotor tip rockets as the sole driving source. FIG. 2 shows a perspective view of the tip end 20 of a “Intora Firebird 2”. One can see part of a rotor blade 22 and a rocket engine 24. The rocket engine 24 has a nozzle 26 for emitting the combustion gas produced by the rocket engine 24.

The power transmission efficiency is just one crucial aspect of helicopters. Since the tip jet driven helicopters are typically less heavy, a smaller lift force is required or the respective helicopter can carry a higher payload.

Many advantages arise from the utilization of gases discharging through the tip of rotor blades. For example, a respective helicopter has a considerably simpler construction than a mechanical helicopter where a central drive system is transferring torque from an engine to the rotor blades. Therefore, the resulting helicopter is lighter. Furthermore, since there is no torque involved in the transfer of power from the fuselage to the rotor, the previously discussed induced fuselage torque does not exist and a tail rotor is not necessary. Indeed, the tail rotor of mechanical helicopters may be a cause of accidents and it adds complexity to the helicopter drive system.

There is a commercial market for helicopters and other aircraft having a tip jet propulsion which overcomes the aforementioned problems and disadvantages of known helicopters.

### TECHNICAL PROBLEM TO BE SOLVED

The objective of the present invention is thus to find the right balance between power transmission efficiency, weight of the helicopter, the payload capacity, the specific air resistance and other parameters so that with a given amount of fuel a maximum travel distance and/or lifting capacity can be ensured.

In essence, the present invention contemplates a helicopter which includes a fuselage and a generally vertical shaft with a lower end mounted within the fuselage. The helicopter also includes at least two rotor blades and a tip-jet rotor drive creating jet streams at the outer tip of each of the at least two rotor blades for propelling the rotor around the vertical shaft.

The helicopter of the invention comprises a compressor with an air inlet for the intake of air and with an air outlet for releasing compressed (hot) air. According to the invention, this compressor is co-axially arranged with respect to the vertical shaft and the compressor is positioned above said rotor blades. The compressor is connected by means of air flow connections to the rotor blades in order to feed equal amounts of compressed air into each of the rotor blades. The compressor, the air flow connections, and the blades are rotating together.

The helicopter comprises a fuel tank for feeding equal amounts of fuel via the rotor blades towards so-called combustion zones. In the area of these combustion zones the fuel and the compressed (hot) air are mixed and combusted so as to produce jet streams.

According to a preferred embodiment of the invention, a piping system is provided for feeding fuel from the fuel tank to the compressor so as to be able to start the compressor.

According to another embodiment of the invention, an auxiliary compressor, preferably a battery-powered compressor, is provided which is in fluid connection with the (main) compressor, so that air or hydraulic fluid emitted by the auxiliary compressor is fed via the fluid connection into the (main) compressor so as to cause this compressor to rotate.

There is zone at the end of each of the rotor blades where the jet stream compressed is redirected before it leaves the rotor blade. The angle of redirection is approximately 90 degrees.

The jet streams established at the tips of the rotor blades point in a tangential direction and provide the thrust required to maintain the rotation of the rotor blades.

According to a preferred embodiment of the invention, a certain quantity of fuel is initially combusted inside the compressor to start the compressors rotation. Once the compressor rotates at sufficient speed, the compressor produces a compressed (hot) air flow which is directed through the air flow connections into the blades. The compressed air flows is mixed with the fuel in or right before the combustion zone and produces the jet stream which is tangentially escaping at each tip.

The compressor produces a compressed air flow which is typically quite hot. In order to protect the rotor blades, in the most preferred embodiments this hot compressed air flow is guided in longitudinal direction through the center portion of the blades towards their ends. Air is caused to enter the blades (as it is flowing against the rotating blades) at the leading and/or trailing edges in order to allow the blade structure to be cooled.

### ADVANTAGEOUS EFFECTS

In view of the drawbacks of the prior art, the objective of the present invention and the inventive solution summarized above, the present invention has the main advantage that there is no need for an engine inside the fuselage. It is also considered to be an important advantage, that there is no need for feeding a high pressure fluid and/or a hot fluid from inside the helicopter through rotating joints or connections into the rotor blades.

The great advantage of the present invention is the straightforwardness and weight reduction as a result of the missing gearbox as well as the torquelessness that can even be achieved with the respective tip jet drive.

Further advantages will become apparent from the detailed description.

### BRIEF DESCRIPTION OF THE DRAWINGS

Further characteristics and advantages of the invention will in the following be described in detail by means of the description and by making reference to the drawings.

FIG. 1 shows a schematic diagram, depicting a known tip jet driven helicopter;

FIG. 2 shows a schematic perspective view of one rotor blade of a known helicopter having a rotor tip rocket;

FIG. 3 shows a schematic perspective diagram, depicting a first tip jet driven helicopter, according to the invention;

FIG. 4 shows a schematic perspective view of the rotor blades of a second tip jet driven helicopter, according to the invention;

FIG. 5A shows a perspective view of the rotor blades of a third tip jet driven helicopter, according to the invention;

FIG. 5B shows a front view of the rotor blades of the helicopter of FIG. 5A;

FIG. 5C shows an enlarged front view of the detail A of FIG. 5B;

FIG. 5D shows an enlarged cross section cut D-D of FIG. 5B;

FIG. 5E shows an enlarged front view of the detail B of FIG. 5B;

FIG. 6 shows a schematic diagram, depicting details of a tip jet driven helicopter, according to the invention;

FIG. 7 shows an enlarged cross section through another rotor blade of a helicopter, according to the invention;

FIG. 8 shows a schematic perspective diagram, depicting another tip jet driven helicopter, according to the invention, which comprises an auxiliary compressor.

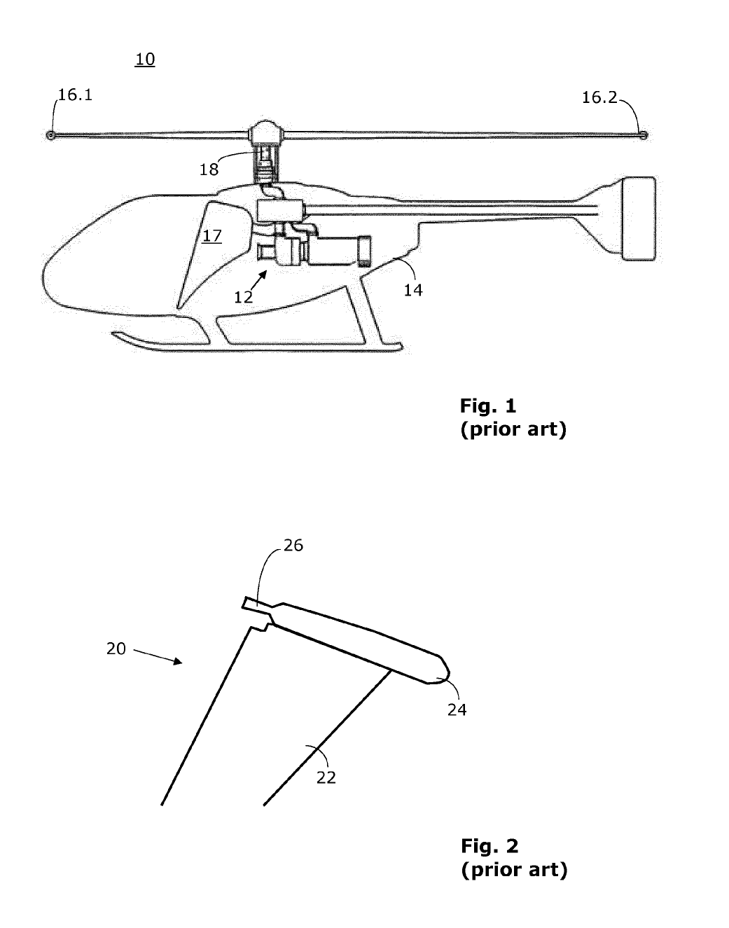

It shall be noted that the figures are not drawn to scale and that certain details have been drawn out of scale for clarity.

### DESCRIPTION OF THE PREFERRED EMBODIMENTS

Terms are herein used which also find use in relevant publications and patents. It is noted however, that the use of these terms shall merely serve a better comprehension. The inventive idea and the scope of the patent claims shall not be limited in their interpretation by the specific selection of the terms. The invention can be transferred without further ado to other systems of terminology.

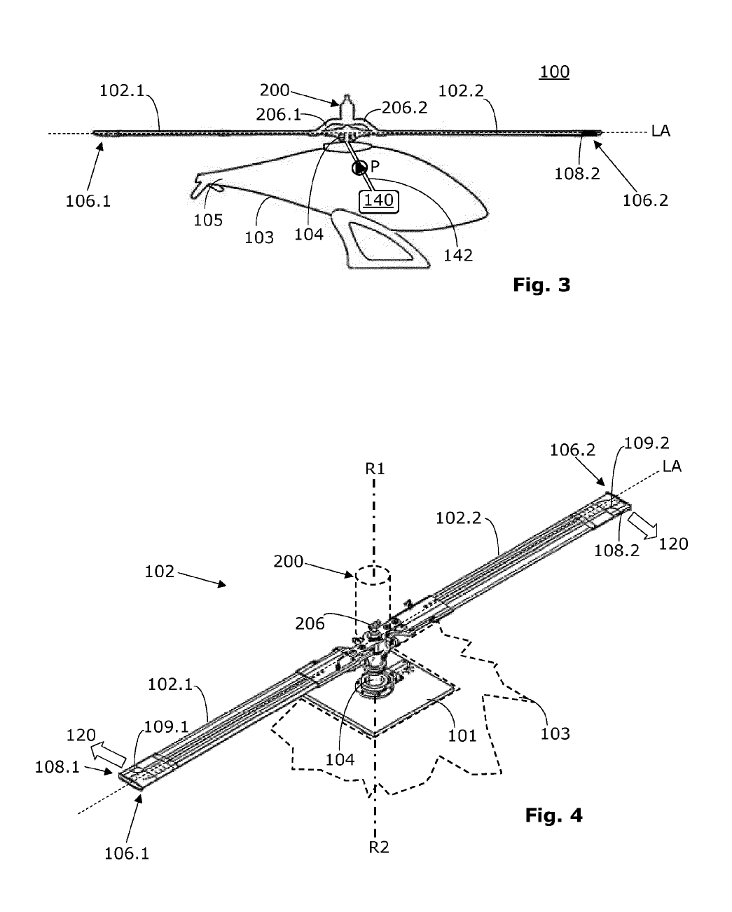

A first embodiment of the invention is now described in connection with the schematic FIG. 3.

The inventive helicopter 100 comprises a tip-jet rotor drive with at least two rotor blades 102.1, 102.2 attached to a central shaft 104. Each rotor blade 102.1, 102.2 comprises means for guiding a combustible fluid (called fuel) from a location close to the central shaft 104 towards the tips 106.1, 106.2. At these tips 106.1, 106.2 there are outlets 108.1, 108.2 pointing into a direction which is essentially perpendicular (615 degrees tilted) to a longitudinal axis LA of the rotor blades 102.1, 102.2. In each of the at least two rotor blades 102.1, 102.2 a jet stream 120 is generated from the fluid and from a compressed hot air stream. The jet streams 120 are streaming out of the outlets 108.1, 108.2 in tangential direction causing a rotational movement of the rotor blades 102.1, 102.2 around the central shaft 104.

In order to provide the compressed hot air streams, the helicopter 100 comprises a (main-) compressor 200 with an air inlet 202 (not visible in FIG. 3) for the intake of air and with one or more air outlets 204 (not visible in FIG. 3) for releasing the compressed hot air. According to the invention, the compressor 200 is co-axially arranged with respect to the central shaft 104 and it is positioned above the rotor blades 102.1, 102.2, as illustrated in FIG. 3. In other words, the compressor 200 sits in a central position on top of the rotor 102. The compressor 200 is connected to the rotor blades 102.1, 102.2 in order to be able to feed equal amounts of the compressed hot air from the air outlet(s) 204 into each of the rotor blades 102.1, 102.2. The connection is done by means of connection tubes or pipes 206.1, 206.2.

The helicopter 100 further comprises a fuel tank 140 (for instance similar to the fuel tank 17 in FIG. 1) and a piping system 142 for feeding equal amounts of fuel from the fuel tank 140 into each of the at least two rotor blades 102.1, 102.2. In FIG. 3 the piping system 142 is shown as an inclined pipe with a fuel pump P. In most embodiments of the invention, part of the piping system 142 runs through the shaft 104.

Each of the rotor blades 102.1, 102.2 comprises a combustion zone 110.1, 110.2 at or close to the respective rotor tips 106.1, 106.2. It further comprises (injection) means for bringing the fuel and the compressed hot air together so that in the combustion zone 110.1, 110.2 a combustion process is maintained. This combustion process produces the jet stream 120. FIG. 3 shows the helicopter 100 at a given instant where at the first tip 106.1 a jet stream 120 is produced which points into the plane of projection. The second tip 106.2 produces a jet stream 120 which points out of the plane of projection.

Each of the rotor blades 102.1, 102.2 has a least one outlet 108.1, 108.2 through which the jet stream 120 is streaming out. In FIG. 3 only the outlet 108.2 is visible.

FIG. 3 also implies that the inventive helicopters 100 are tail-rotor-less helicopters 100. Most embodiments have a short tail 105.

Turning to FIG. 4, details of another embodiment are described. Reference is made to the description of FIG. 3 as far as the respective elements are identical or similar in function.

FIG. 4 indicates that there might be a plate or panel 101 which is part of the fuselage 103. The central shaft 104 is protruding through said plate or panel 101, as illustrated.

The (main) compressor 200 is located on top of the rotor arrangement 102 in a central position. In FIG. 4 the outline of the compressor 200 is indicated by means of its housing or enclosure which is essentially rotationally symmetric (cylindrical).

The compressor 200 has a vertical axis R1 of rotation which coincides with the vertical axis R2 of rotation of the central shaft 104. In all embodiments the compressor 200 is co-axially arranged with respect to the central shaft 104 (expressed in simplified terms: R1=R2).

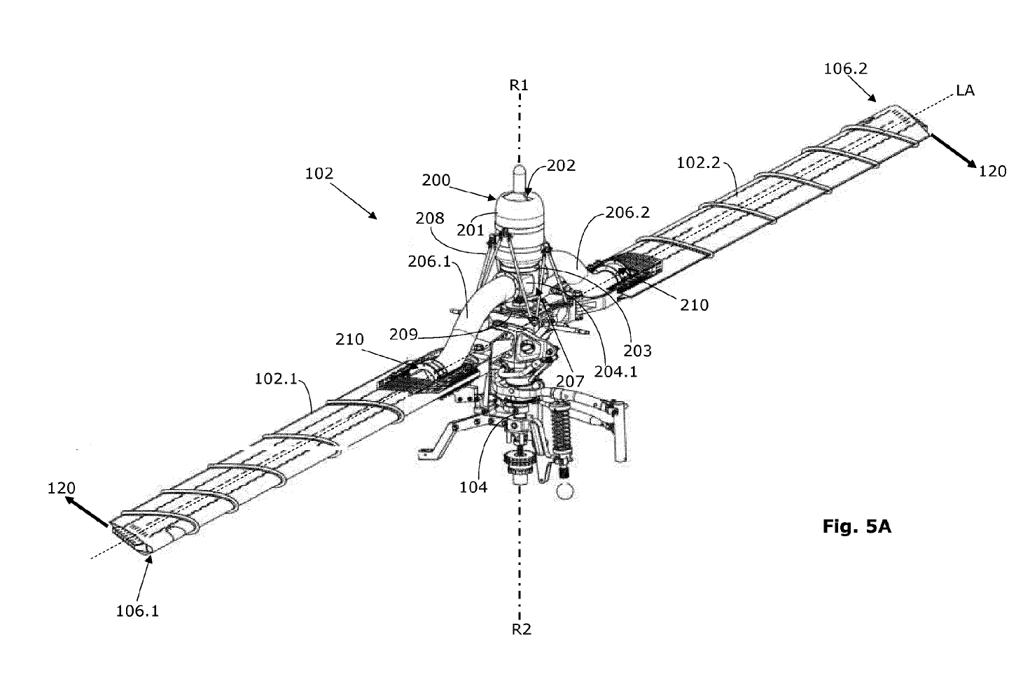

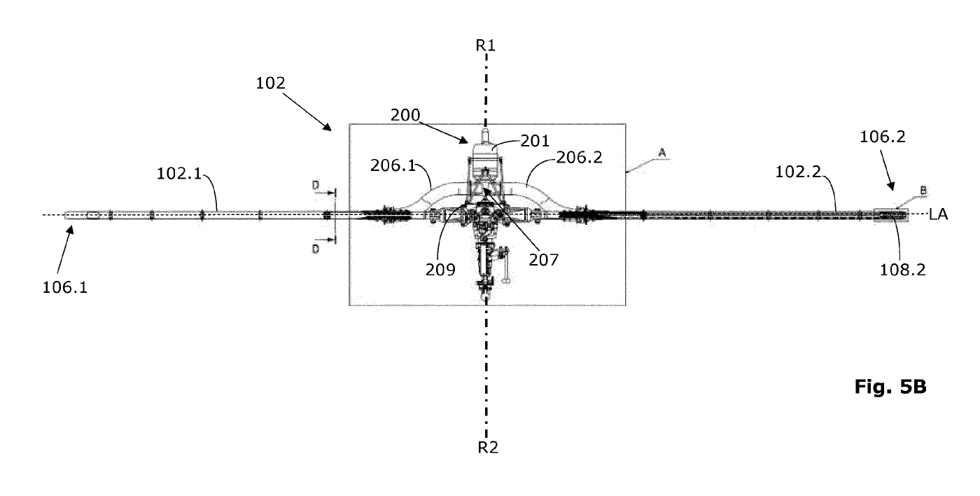

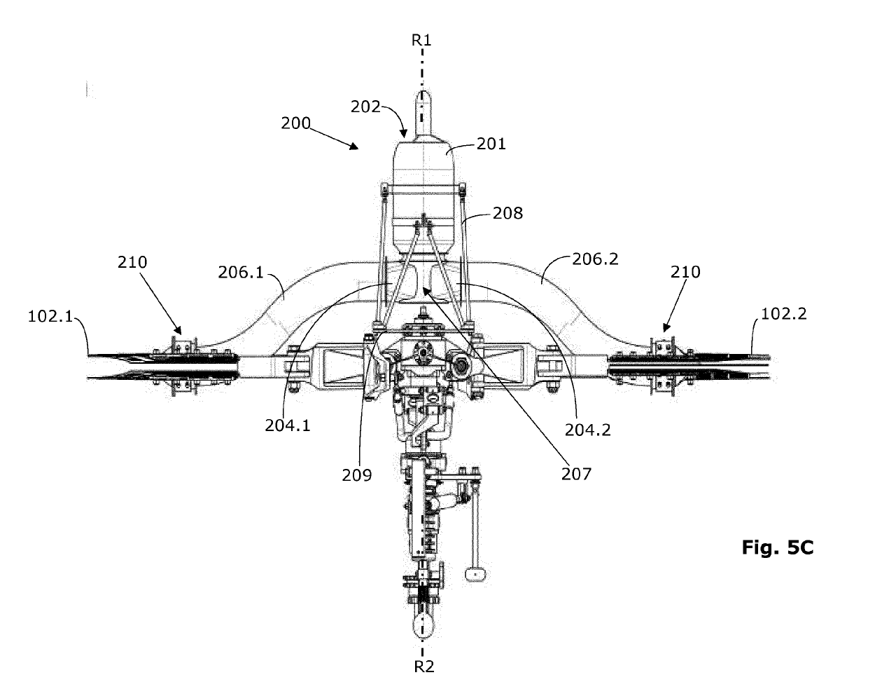

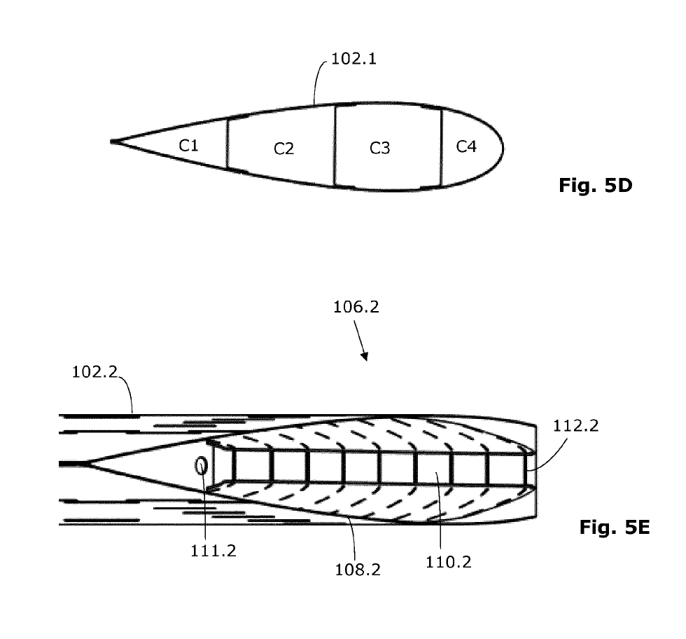

In FIG. 4 there is a T-shaped armature 206 in the central position. Compressed hot air from the air outlet 204 of the compressor 200 is fed via the T-shaped armature 206 into each of the rotor blades 102.1, 102.2. Please note that the embodiments of FIGS. 3 and 5A through 5E have so-called high-pressure pipes 206.1, 206.2 (one per rotor blade 102.1, 102.2) in order to establish a fluid connection for feeding compressed hot air from the air outlet 204 into the rotor blades 102.1, 102.2.

FIG. 4 further illustrates that there may be curved or arched streaming elements 109.1, 109.2 inside each of the rotor blades 102.1, 102.2. These streaming elements 109.1, 109.2 provide for a change of direction (redirection) of the fuel and compressed hot gas (also called mixed fluid). The fuel and the compressed hot gas are streaming independently and essentially parallel to the longitudinal axis LA inside the rotor blades 102.1, 102.2. The streaming elements 109.1, 109.2 deflect or divert the fuel and compressed hot gas before or while being mixed or the streaming elements 109.1, 109.2 are designed for deflecting the mixed fluid (after the fuel and compressed hot gas were mixed).

The jet streams 120 so produced have a tangential direction. Please note that the tangential direction does not have to be perpendicular with respect to the longitudinal axis LA. It can be tilted by 615 degrees. The tangential direction does not have to lie in the plane of rotation of the rotor blades 102.1, 102.2 either. The jet streams 120 can point upwards or downwards and inwards or outwards.

The exemplary illustration of FIG. 4 shows jet streams 120 which are essentially perpendicular with respect to the longitudinal axis LA and which are pointing downwards.

Further details of the invention are now addressed in connection with another embodiment which is illustrated in FIGS. 5A through 5E.

The aspects described above also apply to the embodiment of FIGS. 5A through 5E.

The helicopter 100 of this specific embodiment has a tip-jet rotor drive comprising two rotor blades 102.1, 102.2. The rotor blades 102.1, 102.2 are attached to a central shaft 104. Each rotor blade 102.1, 102.2 comprises means for guiding a combustible fluid (fuel) from a location close to the central shaft 104 towards the tip 106.1, 106.2 of the respective rotor blade 102.1, 102.2. There is an outlet 108.1, 108.2 at or close to the tip 106.1, 106.2 of each rotor blade 102.1, 102.2. Each outlet 108.1, 108.2 points into a direction which may be essentially perpendicular to the longitudinal axis LA of the rotor blade 102.1, 102.2. The outlets 108.1, 108.2 are designed and arranged so that by each of the rotor blades 102.1, 102.2 a jet stream 120 is generated from the fuel mixed with the compressed hot air. These jet streams 120 cause a rotational movement of the rotor blades 102.1, 102.2 around the axis of rotation R2 of the central shaft 104.

The (main) compressor 200 is co-axially arranged on top of the rotor arrangement 102. It has at least one air inlet 202 for the intake of air and at least one an air outlet 204.1, 204.2 for releasing compressed air. The air outlet 204.1 is visible in FIG. 5A. The other air outlet 204.2 is hidden behind the body or housing 201 of the compressor 200.

The compressor 200 is connected to the rotor blades 102.1, 102.2 in order to feed equal amounts of compressed hot air into each of the rotor blades 102.1, 102.2. The respective gas connections are here provided by high-pressure pipes or tubes 206.1 and 206.2.

In order to keep the overall arrangement of elements balanced, care is take that all elements which are rotating around the axis R2 of the central shaft 104 are rotationally symmetric. In case of two rotor blades 102.1, 102.2, the air outlet 204.1 for instance sits right opposite to the air outlet 204.2. Both air outlets 204.1, 204.2 point in a radial direction. And the first high-pressure pipe 206.1 sits right opposite to the second high-pressure pipe 206.2. The reason for this is the reduction of unbalanced masses. The closer the respective elements are located with respect to the center, the less critical their influence is since the lever principle applies.

Since the compressed hot air alone is not sufficient to drive the helicopter 100, a combustible fluid (called fuel) is fed through the rotor blades 102.1, 102.2 towards the tips 106.1, 106.2 in order to feed/maintain combustions. There is a so-called piping system 142 which connects a fuel tank 140 with the rotor blades 102.1, 102.2 and optionally also with the compressor 200.

The fuel tank 140 is in almost all embodiments located inside the fuselage 103. In all embodiments the fuel tank 140 is stationary, which means that this tank 140 does not rotate. This means that one has to provide a fluid connection between the stationary elements of the piping system 142 and rotating elements of the piping system 142. As compared to existing helicopter designs, the piping system 142 is a low pressure system since it only has to accommodate the internal pressure which is required for the pumping of the fuel.

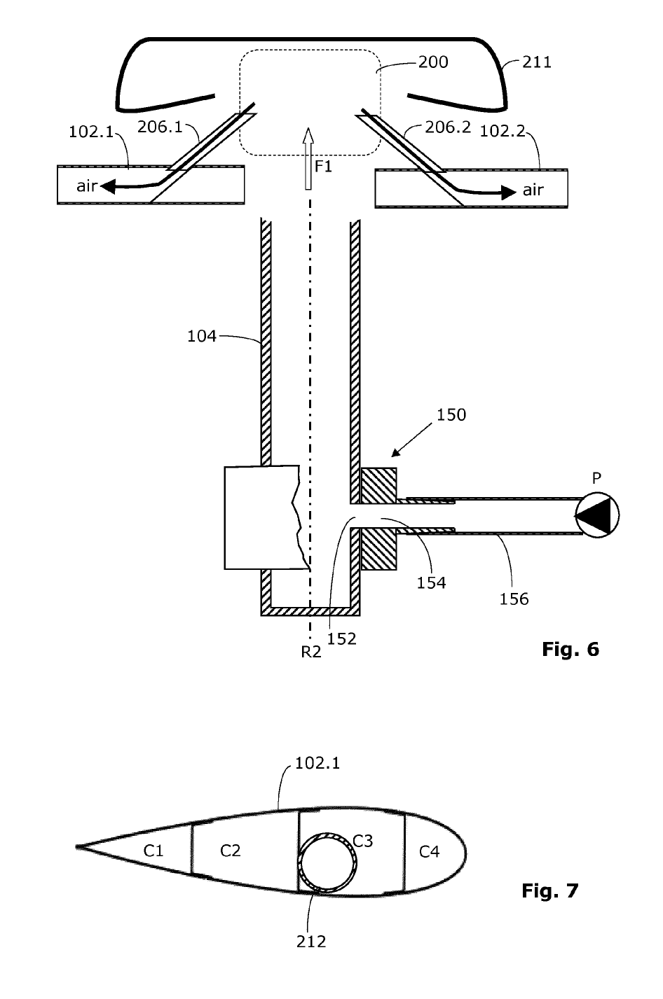

All embodiments comprise a fuel pump P, as schematically depicted in FIG. 3 and FIG. 6. The fuel pump P conveys equal amounts of the fuel from the tank 140 into the rotor blades 102.1, 102.2.

A preferred embodiment is illustrated in the schematic FIG. 6. The central shaft 104 is at least partially hollow so that the fuel can be guided through the shaft 104. Since the shaft 104 rotates together with the rotor blades 102.1, 102.2 around the axis R2, a sliding fluid connection is to be provided somewhere between the stationary tank 140 and the rotating shaft 104. As depicted in FIG. 6. a ring-shaped coupling element 150 can be employed, for instance. The shaft 104 is rotating inside a bore hole of the coupling element 150. A pressure tight connection is provided between the coupling element 150 and the shaft 104 in that the shaft 104 comprises at least one inlet hole 152 and the coupling element 150 comprises a through hole 154. A pipe 156 might connect the pump P with the coupling element 150. The shaft 104 either comprises several inlet holes 152 in radial arrangement or the coupling element 150 comprises a chamber having a certain circular dimension.

Such coupling elements 150 and similar arrangements are known in the art. It is thus not a problem for a person skilled in the art to provide a reliable and fuel tight connection in order to feed low-pressure fuel from the tank 140 into the rotor blades 102.1, 102.2.

The same or a similar kind of fuel connection can be used in order to feed fuel into the compressor 200, if a compressor 200 is employed which is started with fuel.

Short sections of the two rotor blades 102.1, 102.2 are illustrated in FIG. 6. Since these rotor blades 102.1, 102.2 rotate with the same angular velocity as the shaft 104, the mechanical connection as well as the fluid connection F between the shaft 104 and the blades 102.1, 102.2 are not critical. The fluid connection F are illustrated by means of two block arrows F. The optional fluid connection F1 for feeding the compressor 200 with fuel is illustrated by means of a block arrow F1.

FIG. 6 indicates that the shaft 104 as such serves as fuel pipe. All embodiments might comprise such a shaft 104 serving as fuel pipe, but it is also possible to provide a so-called inner fuel pipe which is sitting inside the shaft 104. The function is essentially the same.

Coming back to FIG. 5A, one specific arrangement for the mounting of the compressor 200 is described. The compressor 200 comprises a housing or enclosure 201. This housing or enclosure 201 may be mounted by means of a flange 203 to a body 207. In the present embodiment the air outlets 204.1, 204.2 are an integral part of the body 207.

Either the body 207 is connected mechanically directly or indirectly to the shaft 104, or the housing or enclosure 201 is mounted inside a frame structure 208 which as such is connected mechanically directly or indirectly to the shaft 104. FIGS. 5A through 5C show an embodiment where a frame structure 208 is employed.

The embodiment of FIGS. 5A through 5C comprises a frame structure 208 with several bi-pods or tri-pods. These bi-pods or tri-pods are connected with a common point to the housing or enclosure 201 and their individual ends are fixed to a bottom frame or plate 209.

Most helicopters have rotor blades which can be individually tilted around the longitudinal axis LA (pretty much like flaps of an aircraft) in order to control the flight of the helicopter.

The helicopter 100 of the invention preferably is equipped with known (e.g. electro-mechanical or hydraulic) elements to enable the individual tilting of the blades 102.1, 102.2. The respective mechanical elements are shown in the FIGS. 5A through 5C but not addressed in further detail. Reference is made to standard literature about helicopter controls.

It is important to note that in connection with the present invention the high pressure pipes 206.1, 206.2 have to be coupled to the rotor blades 102.1, 102.2 so that the blades 102.1, 102.2 can be tilted around the longitudinal axis LA while the high pressure pipes 206.1, 206.2 are not tilted, rotated (except for the common rotation of all elements around the axis R2) or twisted. This is important because solid and robust high-pressure connections for the hot air are required.

It is thus advantageous to ensure a tight high-pressure connection between the compressor 200 and the blades 102.1, 102.2 where the central axis of symmetry of the pipes 206.1, 206.2 is positioned co-axially with respect the tilt axis. In most cases the tilt axis is identical with the longitudinal axis LA or the tilt axis is slightly offset with respect to the axis LA. This applies to all embodiments having tiltable blades 102.1, 102.2.

Preferably, all embodiments comprise rotating joints 210 (see FIG. 5C) in order to connect the high pressure pipes 206.1, 206.2 with the rotor blades 102.1, 102.2.

The outlet 108.2 of the rotor blade 102.2 is visible in FIG. 5B at the right hand side. An enlarged view of the detail B is shown in FIG. 5E. Detail A is shown in FIG. 5C and a section along the line D-D is shown is FIG. 5D.

Further details of the preferred embodiment are visible in FIG. 5B and 5C. In these Figures the symmetry of the overall rotor arrangement 102 is visible: the element 204.1 is opposite to the element 204.2; the element 206.1 is opposite to the element 206.2. Even the bi-pods of the frame structure 208 are designed with an eye on the symmetry.

In FIG. 5C one can see several elements of the frame structure 208. There is a first bi-pod arranged in parallel to the projection plane sitting in front of the compressor housing or enclosure 201 and a second bi-pod arranged in parallel to the projection plane but sitting behind (not visible in FIG. 5C). There are two further bi-pods on the left and right hand side. The bottom frame or plate 209 is distinctly visible in FIG. 5C. One can see that the bottom frame or plate 209 is centrally mounted to an upper end 211 of the central shaft 104 or to a co-axial extension of the central shaft 104.

FIG. 5C makes some of the elements clearly visible which are used, as known in the art, in order to control the position of the rotor blades 102.1, 102.2.

The rotor blades 102.1, 102.2 of the invention either each have one channel, conduit or pipe for guiding the compressed air together with the fuel towards the tips 106.1, 106.2, or there are at least two separate channels, conduits or pipes. One of the these channels would be guiding the compressed hot air whereas the other one would be guiding the fuel.

In all embodiments, however, these channels, conduits or pipes extend from a position close to the axis R2 to a position near the tip 106.1, 106.2.

Preferably, all embodiments have two separate channels, conduits or pipes so that the compressed hot air and the fuel is mixed or interlaced at or in the combustion zones 110.1, 110.2.

Preferably, the combustion zones 110.1, 110.2 of all embodiments are designed so that a vaporization occurs or that the two fluids (i.e. the compressed air and the fuel) form a fuel spray.

Preferably, the compressor 200 of all embodiments is designed so that the compressed air is hot (at least 400° C.). The pressure of the compressed air is more than ______ when it reaches the combustion zone 110.1, 110.2. These conditions (temperature and pressure) lead to the formation of the mixture together with the fuel which either shows auto-ignition properties or which can be easily and effectively ignited using a spark plug or glow element.

Preferably, all embodiments have a spark-ignitable set-up where the ignition spark is controlled from a control system (e.g. a flight control box) inside the helicopter 100. In this case a rotating contact element at the shaft 104 and corresponding cables connect the spark plugs with the control system.

FIG. 5D shows a cross-section along the line D-D of one of the rotor blades 102.1. The rotor blades 102.1, as is known in the art, have a very robust and hollow configuration.

In a preferred embodiment, the rotor blades 102.1 are divided in various chambers C1, C2, C3, C4 each having an essentially longitudinal orientation (mainly parallel to the axis LA). One or two of these chambers (e.g. the chambers C2 and C3) might serve as channels, conduits or pipes, as mentioned above.

In another preferred embodiment, the rotor blades 102.1 are again divided in various chambers C1, C2, C3, C4. The chamber C2 might serve as channel for the compressed air whereas a separate pipe 212 is positioned inside the chamber C3, as depicted in FIG. 7. The fuel might be pumped through the pipe 212 to the combustion zone 110.1, 110.2.

FIG. 5E shows an enlarged view of the detail B of FIG. 5B. The viewing direction enables the look into the combustion chamber 110.2 of the rotor blade 102.2.

In a preferred embodiment, the combustion chambers 110.1, 110.2 are cavities inside the respective rotor blade 102.1 or 102.2. This may apply to all embodiments.

In a preferred embodiment, each combustion chamber 110.1, 110.2 has a nozzle or inlet 111.1, 111.2 through which the mixed fluid (compressed air together with fuel) are sprayed or pressed into the combustion chamber 110.1, 102.2. This may apply to all embodiments, too.

Preferably, all embodiments have combustion chambers 110.1, 110.2 where stream-influencing elements 112.1, 112.2 are placed in each combustion chamber 110.1, 110.2. FIG. 5E shows an embodiment where fins, panes or ridges serve as stream-influencing elements 112.1, 112.2.

In order to be able to start the helicopter 100 without external assistance, the helicopter 100 either comprises an auxiliary compressor 300 (see FIG. 8) or a gas bottle (not shown).

The auxiliary compressor 300 may be battery-powered or fuel-powered and it has a fluid connection with the (main) compressor 200, so that air emitted by the auxiliary compressor 300 is fed via the fluid connection into the main compressor 200 so as to cause the compressor 200 to rotate. A respective example is shown in FIG. 8. Please note that here the fuel pump P is a submerged fuel pump which sits inside the fuel tank 140. Once the (main) compressor 200 rotates properly, the auxiliary compressor 300 can be switched off and the rotation is maintained by spark-igniting or by auto-ignition of the fuel together with the compressed hot air.

The (pressurized) gas bottle may be designed so that it emits a gas which is fed via a fluid connection into the compressor 200 so as to cause said compressor 200 to rotate.

Preferably, all embodiments have a gas bottle which can be re-filled by the compressor 200 during full operation.

Preferably, all embodiments comprise a hot gas generator or a jet engine, preferably a turbo jet engine, as compressor 200, which is designed in order to internally rotate with a velocity of up to 80000 rpm.

It will be understood that many variations could be adopted based on the specific structure hereinbefore described without departing from the scope of the invention as defined in the following claims.

What is claimed is:

1-11. (canceled)

12. Helicopter with tip-jet rotor drive comprising at least two rotor blades attached to a central shaft, where each rotor blade comprises means for guiding a fluid from a location close to said central shaft towards a tip of the rotor blade and where at the area of said tip there is an outlet of said rotor blade, arranged so that by each of the at least two rotor blades a jet stream is generated from said fluid, said jet stream causing a rotational movement of the rotor blades around said central shaft, said helicopter comprising a compressor with an air inlet for the intake of air and with an air outlet for releasing compressed air, and a fuel tank,
characterized in that
said compressor is co-axially arranged with respect to said central shaft,
said compressor is arranged above said rotor blades,
said compressor is connectable to said at least two rotor blades in order to feed equal amounts of compressed air into each of said at least two rotor blades,
a piping system for feeding equal amounts of fuel from said fuel tank into each of said at least two rotor blades,
wherein each of said least two rotor blades comprises a combustion zone,
means for bringing said fuel and said compressed air together so that in said combustion
zone a combustion process is maintained which produces said jet stream.

13. Helicopter according to claim 12, comprising an auxiliary compressor, preferably battery-powered, in fluid connection with said compressor, so that air emitted by said auxiliary compressor is fed via said fluid connection into the compressor so as to cause said compressor to rotate.

14. Helicopter according to claim 12, comprising a gas bottle in fluid connection with said compressor, so that air emitted by said gas bottle is fed via said fluid connection into the compressor so as to cause said compressor to rotate.

15. Helicopter according to claim 12, wherein said piping system comprises:
a low-pressure fluid connection
an inner fuel pipe situated inside said central shaft, and
a rotating portion,
said low-pressure fluid connection providing for a fluid connection between said tank and said inner fuel pipe, and said rotating portion providing for a fluid connection between said inner fuel pipe and each of said at least two rotor blades.

16. Helicopter according to claim 15, wherein a rotating fluid coupling is provided in order to provide for said fluid connection between said inner fuel pipe and each of said at least two rotor blades.

17. Helicopter according to claim 12, comprising a fuel pump (P) in fluid connection with said fuel tank, said fuel pump (P) being located inside said helicopter.

18. Helicopter according to claim 12, wherein said compressor is connected to said at least two rotor blades by means of one high-pressure pipe per rotor blade.

19. Helicopter according to claim 12, wherein said compressor is directly connected to said at least two rotor blades and wherein the connections providing for the direct connection rotate together with said compressor and said at least two rotor blades.

20. Helicopter according to claim 18, wherein said compressor is a hot gas generator being designed in order to release the compressed air at said air outlet having a temperature of at least 400 Degrees Centigrade.

21. Helicopter according to claim 18, wherein said compressor is a jet engine, preferably a turbo jet engine.

22. Helicopter according to claim 12, further comprising a rotor disc which is mounted in a central position above said compressor.
